(19) United States
(12) Patent Application Publication
(10) Pub. No.: US 2006/0213497 A1
(43) Pub. Date: Sep. 28, 2006

(54) Barbeque grill

(76) Inventors: Miguel De Jesus Orozco, Lakewood, CA (US); Rodolfo H. Madariaga, North Hills, CA (US)

Correspondence Address: TERRELL P. LEWIS, UNIT #8, 343 PALOS VERDES BOULEVARD, REDONDO BEACH, CA, 90277, US

(21) Appl. No.: 11/086,697

(22) Filed: Mar. 22, 2005

(51) Int. Cl. A47J 37/00; F24C 3/00

(52) U.S. Cl. 126/41 R

(57) ABSTRACT

A barbeque grill assembly having a cooking chamber includes a liquid reservoir, a first grilling member supported above the reservoir, the first grilling member including a foraminous planar element on which food to be grilled is arranged, a cylindrical stack arranged centrally of the reservoir, and a cover disposed over the reservoir, the first grilling member and the stack. At least one of the cover and the stack includes an air flow impacting member for radially dispersing warmed air throughout the cooking chamber. A heat source is disposed beneath the liquid reservoir, and the stack communicates air heated by the heat source with the cooking chamber. The stack comprises a tube having a diameter and an elongated longitudinal axis extending from a region adjacent the heat source to a region adjacent the central portion of the cover. The stack includes air swirling means projecting into or towards the conduit formed by the stack. One form of the air swirling means is an array of deformed areas on the stack surface which comprises helically arranged inner wall protuberances projecting into the interior of the stack. To further enhance the swirling of heated air within the cooking chamber, the surface of the cover that overlies the stack may be formed with a conical formation at the central region thereof.

### BACKGROUND OF THE INVENTION

1. Field of the Invention

The present invention relates to food grilling devices and the like, and more particularly to a barbeque grill apparatus capable of cooking meats, chicken, fish, fowl, or vegetables, which can be used indoors or outdoors and in which the food is cooked in a convective environment without directly contacting the heat source. Even more particularly, the present invention is concerned with a food grilling apparatus defining a cooking chamber including a first cooking surface wholly contained within the cooking chamber, and a second cooking surface located outside the cooking chamber, in which the first cooking surface, and hence the food on the cooking surface, never contacts the heat source, and which cooking chamber is configured to create a convective environment for moving the heated air in the cooking chamber in a path from the heat source, over the food, and into the ambient.

2. Description of the Related Art

Barbeque cooking is typically a combination of both radiant cooking and convective cooking, and involves placing food on a grill or similar grill-work cooking surface and positioning the cooking surface above a heat source. Typically, the heat source is a bed of coals or other combustible materials, or a flame from a gas driven source. During cooking, the heat source warms the air surrounding the source, which in turn rises and by convection and radiation cooks the food on the cooking surface. Grease and natural juices from the cooking food then drips down onto the heat source, and as the grease sears and burns, fumes spiral upwardly to the cooking food to impart a unique barbeque taste.

The most basic and popular outdoor grilling devices are designed to use a combustible material, such as charcoal or wood, as a source of heat. Charcoal produces noxious fumes when heated that present a serious health hazard if allowed to collect in a confined area, such as a room in a house, tent, motor home, etc, where the fumes can be inhaled. In addition, combustion of charcoal or wood produces as a side product a messy ash deposit within the grilling device that is often difficult to completely contain and later clean. And, when fatty foods are cooked directly over charcoal or wood, juices and the fat mix to produce a greasy substance which, when contacting the hot coals or wood, typically produces smoke or bursts into flames. Consequently, outdoor grilling devices which are limited solely to the use of such combustible fuels as charcoals and wood as a source of heat are not well suited for indoor use.

Virtually all indoor barbeque grilling devices possess a grill and grate shelf arrangement, but the charcoal and/or wood is replaced with lava rock or other suitable heat-retentive materials. These materials, when heated from below either by an electric burner or a gas burner, produce sufficient heat to cook the foods placed on the grill shelving in much the same manner as the burning charcoal or wood, but without the production of fumes or residue. Nevertheless, it is impossible to cook using these materials without producing some amount of smoke, and it appears that the grilling devices of the prior art incorporate an exhaust fan or vent overlying the stove or cooking area to remove the smoke for discharge to the ambient, which if the latter is in the home, these known grilling devices are still unsuitable for indoor grilling.

Although portable barbeque units of various designs are well known, few are capable of both indoor use and outdoor use. Portable barbeque devices are generally usable only with charcoal or wood as the heating source, and are thus restricted to outdoor applications only.

In an effort to overcome the limitations that attach to such portable cooking devices, grilling apparatus has been developed that will cook food indoors and outdoors. Most foods that are to be grilled inherently possess or hold a liquid, whether such liquid is juice from meats or water from vegetables, when the liquid is expelled from the cooking food and mixes with fat in one form or another, invariably a greasy substance is formed which when it drips from the cooking food, tends to produce smoke when heated. In an effort to diminish the smoke, grilling devices have been provided with water reservoirs to collect, cool, and congeal the fatty substances before they have a chance to be heated to the point of giving off smoke.

Further, most meat products that are cooked using barbeque grills tend to be severely burned due to the generation of flames when the juices of the meat fall upon the charcoal or wood embers and are heated to combustion. This results in charring of the food being barbequed, such that the outer surface of the food is burned while the inside of the food is uncooked or undercooked.

### SUMMARY OF THE INVENTION

The present invention provides a versatile and enjoyable alternative to the traditional and previously known barbequing experiences by providing a grilling device that cooks food by a combination of convection heating, steam heating, and grilling.

In one aspect of the invention, there is provided a barbeque grill kit which includes a cooking chamber having a convection heating area and a grilling area, and further including means, cooperating with the cooking chamber, for steam heating the cooking food.

Another aspect of the invention provides a barbeque grill kit having a heat source with a heat-conveying mechanism and a heat distributing mechanism, both being configured to evenly conduct and distribute heat from the heat source over all of the cooking areas.

In another aspect of the invention, there is provided a barbeque grill kit having a cover that encloses and defines the cooking chamber and also functions as a food warming surface.

In yet another aspect of the present invention, there is provided a compact, portable, barbeque grill kit which further includes a cylindrical stack for conducting the air heated by the heat source away therefrom and upwardly toward the inner surface of a cooking chamber cover where it impacts and is radially distributed toward the grilling areas of the barbeque grill.

In another aspect of the invention, the inner surface of the cooking chamber cover is provided with a radially extensive heat distribution element for imparting radially directed motion to the heated air.

In still another aspect of the present invention, the stack can be formed with a cover or lid having upwardly inclined fins arranged about the surface of the lid.

In still another aspect of the invention, the cylindrical portion of the stack is formed with helically arranged, spaced, inwardly projecting protrusions for imparting a helical motion to the heated air while the air is still within the stack and before it impacts the cover.

In another aspect of the invention, the barbeque grill kit includes a strap for easy portage of the kit.

In another aspect of the invention, the barbeque grill kit is assembled into a self-contained, portable, package which can also be provided with fuel.

Still another aspect of the invention entails a portable barbeque grill kit that includes its own heat source and support legs.

These and other aspects, advantages and features of the invention will become more apparent, as will equivalent structures which are intended to be covered herein, with the teaching of the principles of the invention in connection with the disclosure of the preferred embodiments thereof in the specification, claims and drawings in which:

### BRIEF DESCRIPTION OF THE DRAWINGS

FIG. 1 is a cross-sectional view of a first embodiment of the barbeque grill assembly of the present invention;

FIG. 2 is an exploded view of the grill assembly shown in FIG. 1;

FIGS. 3a and 3b are perspective views of the burner assembly and its connection with the grill assembly of FIG. 1, respectively;

FIGS. 4a-4c show one variation of the heat conveying stack shown in the grill assembly of FIG. 1;

FIGS. 5a-5c show a second variation of the heat conveying stack shown in the grill assembly of FIG. 1;

FIGS. 6a-6c show a third variation of the heat conveying stack shown in the grill assembly of FIG. 1;

FIG. 7 is a cross-sectional view of a second embodiment of the barbeque grill assembly of the present invention; and

FIGS. 8a-8c depict a variation of the cover air diffuser depicted in FIG. 1 used with the grill assembly shown in FIG. 7.

### DETAILED DESCRIPTION OF THE INVENTION

The following description is provided to enable any person skilled in the art to make and use the invention and sets forth the best modes contemplated by the inventor of carrying out this invention. Various modifications, however, will become readily apparent to those skilled in the art since the generic principles of this invention have been defined herein specifically to provide a barbeque grill apparatus which is portable, easy to use, and inexpensive to manufacture.

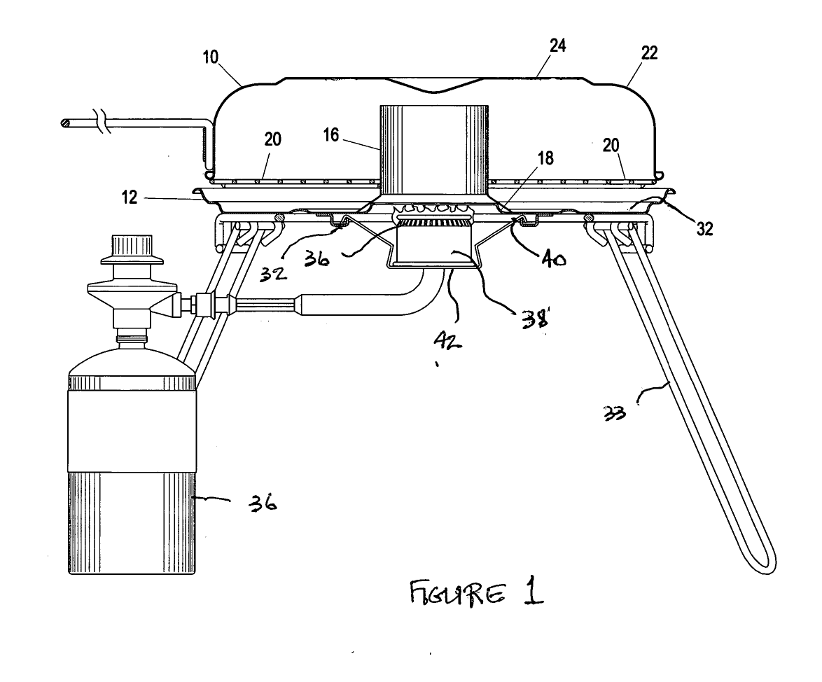

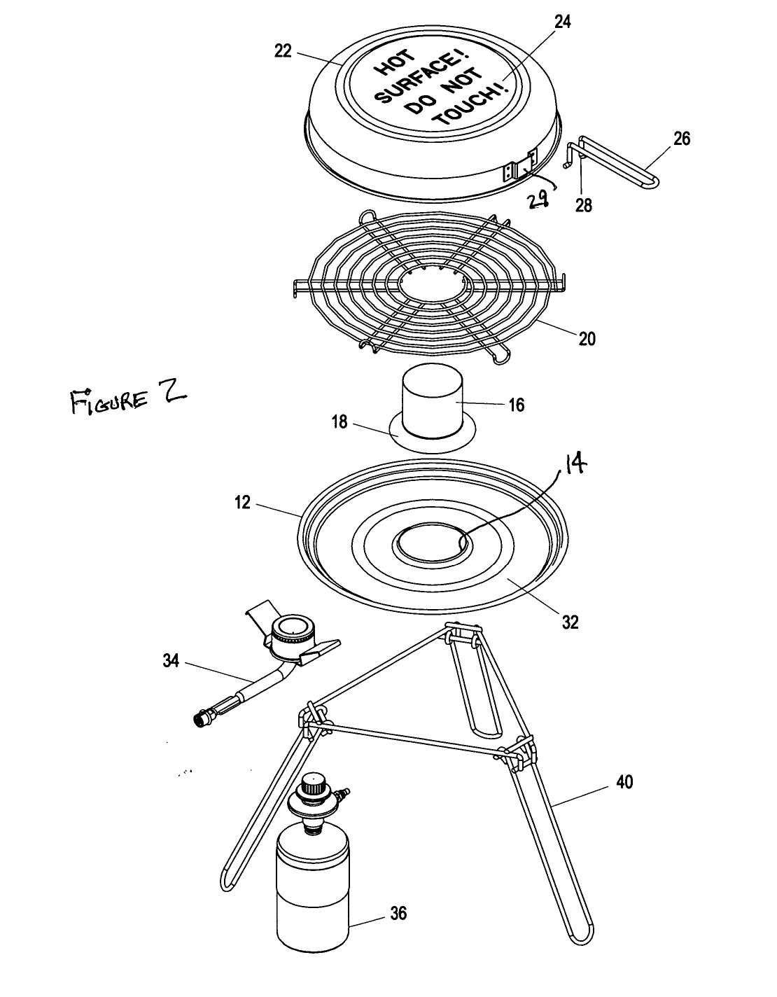

Referring now to FIGS. 1 and 2 of the drawing, a first embodiment of the grill assembly 10 of the present invention is shown to include a first annular element 12 comprising a substantially circular plate element with a central opening 14, a second annular element 16 comprising a cylindrical stack having an outwardly directed annular flange 18 at one end thereof, a substantially planar wire grill work element 20 of circular configuration, and a cover 22 having a solid covering surface 24. A handle 26 is preferably mounted to one side region of the cover. Preferably, the handle is detachably mounted to the cover by one or more handle projections 28 that engage in and secure the handle to a handle latching element 29 on the side of the cover. The detachability of the handle is desired not only for packaging all grill components up when the cooking has been completed and it is time to go home, but also so that overheating of the handle and burning of the user's skin during cooking of the food can be avoided.

The first annular element 12 includes an annular groove 32 that is configured as a shallow dish portion and contains a liquid capable of emitting water vapor when heated, such as water. The purpose of the liquid is to catch and congeal drippings from the food being grilled, as well as to provide steam when the liquid is heated to a level capable of causing the evaporation of the liquid so that smoke particles present in the vicinity of the cooking food become weighted down with the heated moisture and fall into the annular groove 32. The annular groove 32 can be preferably located adjacent the outer periphery of the element 12. In the alternative, the annular groove 32 can be spaced radially inwardly from the outer periphery of the first element 12 (as shown in FIGS. 1 and 2).

Preferably, when the grill assembly 10 is used indoors, the heating source can be a stove-top burner (not shown) or a portable propane gas burner 34 fueled by propane released from a gas container 36 (see FIG. 1). It is to be understood that other vapor or liquid fuels may be used as well.

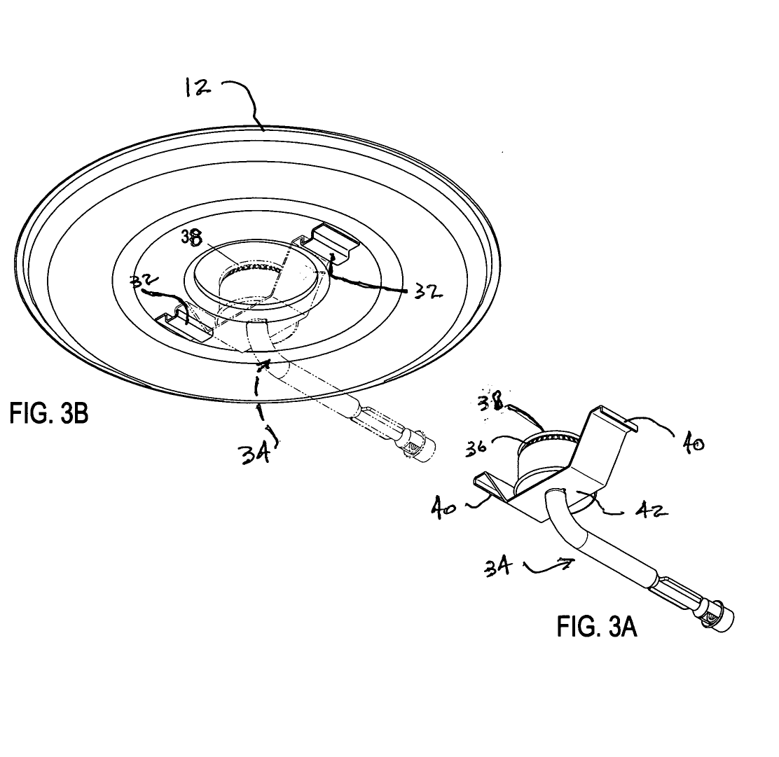

FIG. 3 shows a burner assembly 34 attached to the underside of the first annular element 12 in such a manner that the gas emitting openings 36 surrounding the burner portion 38 of the burner assembly are disposed directly below (or even within) the opening 14 in the annular element 12. The burner portion 38 of the burner assembly 34 is attached to the underside of the first element 12 through the interconnection of flanges 32 that define a female connector, the flanges 32 being secured to the underside of the element 12 adjacent to, and below, the opening 14, and end portions 40 of a bracket 42. The central portion of the bracket 42 engages the rear side of the burner portion 38 when the bracket is engaged with, and suspended from, the flanges 32.

It is to be understood that when using the propane container and burner assembly 34 as the heating source, the grill assembly 10 of the present invention needs to be supported above the ground at a height sufficient to accommodate the height of the propane gas container. Preferably, the means for raising the grill assembly 10 above the “ground” surface is a stand 40, which can be included as one of the elements of the barbeque grill assembly 10. Alternatively, the stand 40 can be provided to the barbeque grill user as an after-market item.

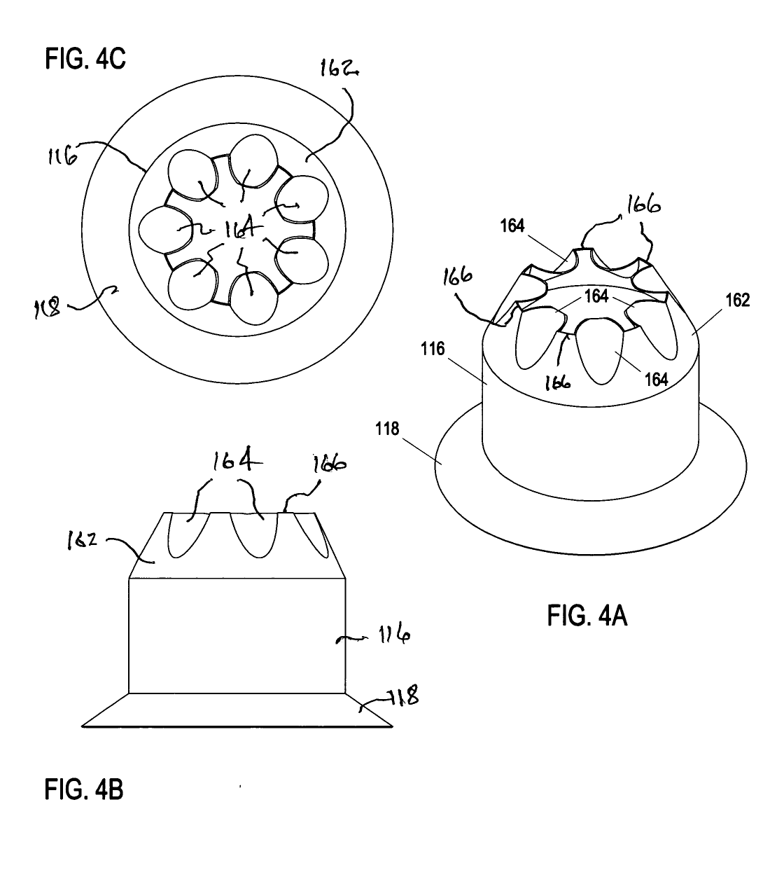

FIGS. 4a-4c depict a first variation 116 of the cylindrical stack element shown in the grill assembly of FIG. 1, in which FIG. 4a is a perspective view of stack 116, FIG. 4b is a side view of stack 116, and FIG. 4c is a top view of the stack 116 looking down on FIG. 4b. The cylindrical stack element 116 includes at the bottom end an outwardly directed annular flange 118, and at the top a radially inwardly slanted portion 162 exhibiting an array of flutes comprising radially inwardly formed depressions 164 separated by equidistantly spaced circumferential walls 166. The flutes are provided for the purpose of constricting the flow of heated air passing through the upper portion of the stack while also increasing the velocity of heated air as it emanates from the opening at the top of the stack.

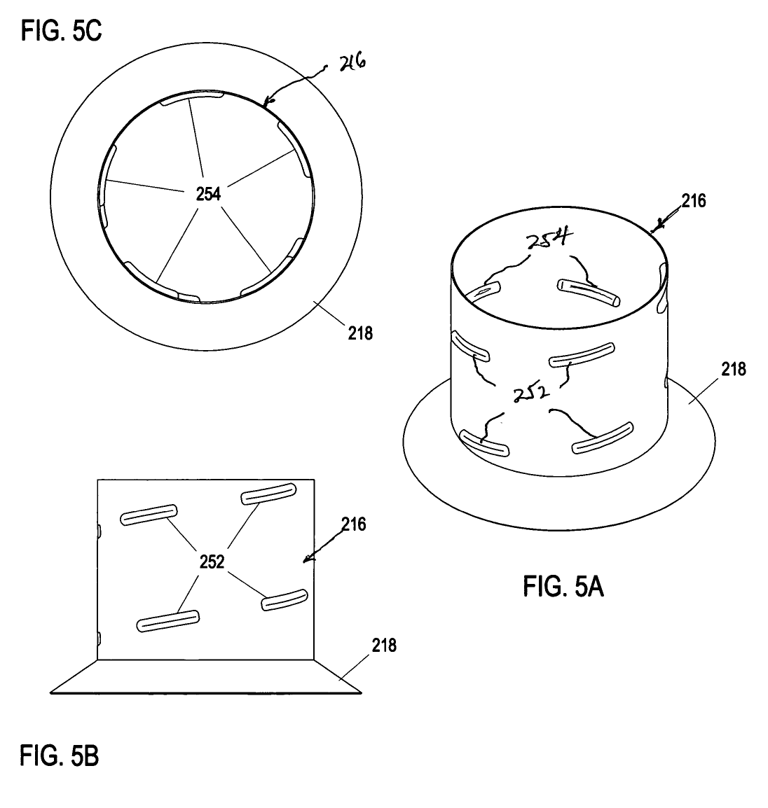

FIGS. 5a-5c depict a second variation 216 of the cylindrical stack element shown in the grill assembly of FIG. 1, in which FIG. 5a is a perspective view of stack 216, FIG. 5b is a side view of stack 216, and FIG. 5c is a top view of the stack 216 looking down on FIG. 5b. The cylindrical stack element 216 includes at the bottom end an outwardly directed annular flange 218. The stack 216 is formed as a right cylinder with the top end being of substantially the same diameter as the bottom end. Disposed about the outer surface of the stack 216 is a helical arrangement of circumferentially spaced, radially inwardly directed indentations 252 which, on the inner surface of the stack, result in inwardly directed protrusions or fins 254. The fins impact the flow of heated air passing through the stack 216 to cause the air to flow within the stack in a helical motion and simultaneously increase the velocity of air passing through the stack so that when emanating from the opening of the stack at the top thereof, the heated air is swirling upwardly with a rapid motion.

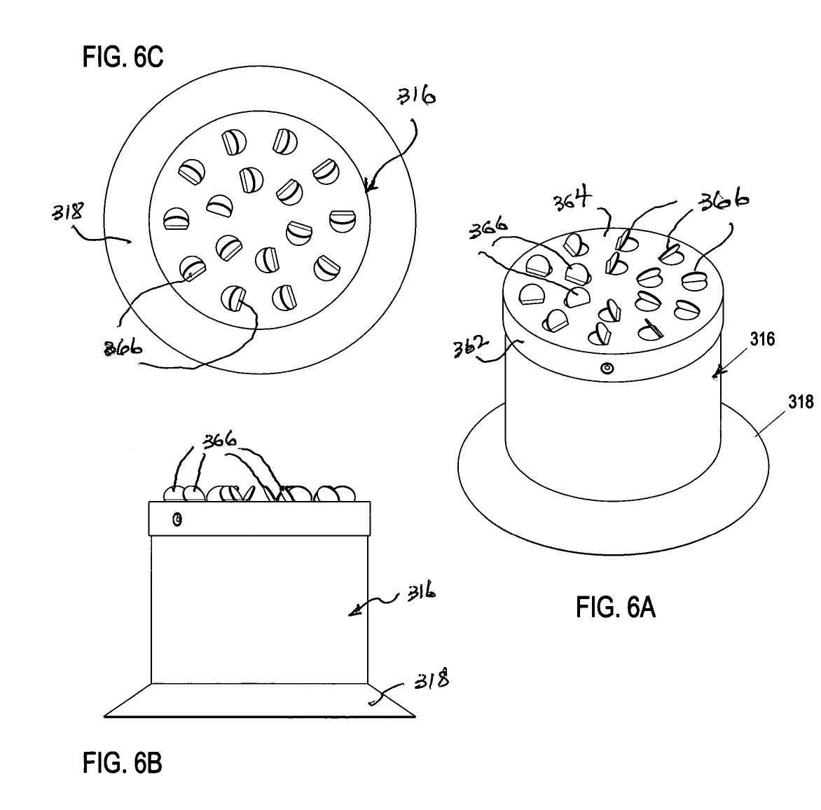

FIGS. 6a-6c depict a third variation 316 of the cylindrical stack element shown in the grill assembly of FIG. 1, in which FIG. 6a is a perspective view of stack 316, FIG. 6b is a side view of stack 316, and FIG. 6c is a top view of the stack 316 looking down on FIG. 6b. The cylindrical stack element 316 includes at the bottom end an outwardly directed annular flange 318. The stack 316 is formed as a right cylinder with the top end being of substantially the same diameter as the bottom end. Disposed at, and secured to the top of the stack 316 is a cap 362 having an annular side portion depending from a planar top plate 364 in which an array of upwardly-directed, punched out, flaps 366 are arranged in circular rows. As shown in FIGS. 6A and 6C, the flaps are arranged at an acute angle to the top plate 364, and are all punched out of the top plate in the same direction and at substantially the same angle. It is to be understood, however, that the outer array of flaps and the inner array of flaps could be oppositely directed, that is the flaps in the outer circular array could be punched out and arranged in a clockwise direction while the flaps in the inner circular array could be punched out and arranged in a counter-clockwise direction (or vice versa). The flaps 366 are provided for the purpose of directing the heated air flowing through the stack out of the stack and in a helical motion. The stack 316 may also have a smaller diameter at the top thereof that at the bottom adjacent the flange 318 with the effect that the velocity of the air flowing through the stack will be increased when emanating from the stack at the top thereof with the heated air swirling upwardly and into impingement with one of the embodiments of air dispersement carried by the underside of the grill cover.

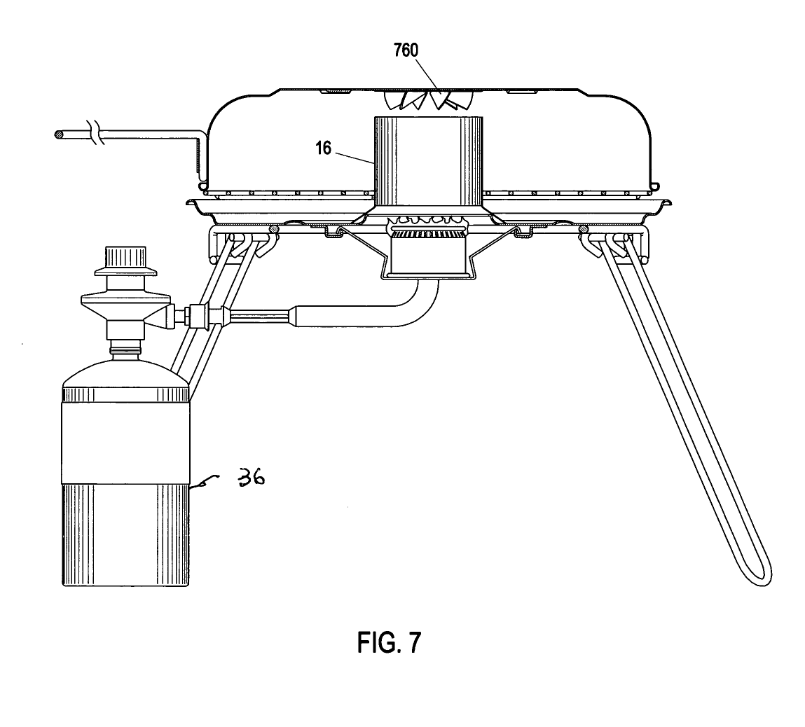

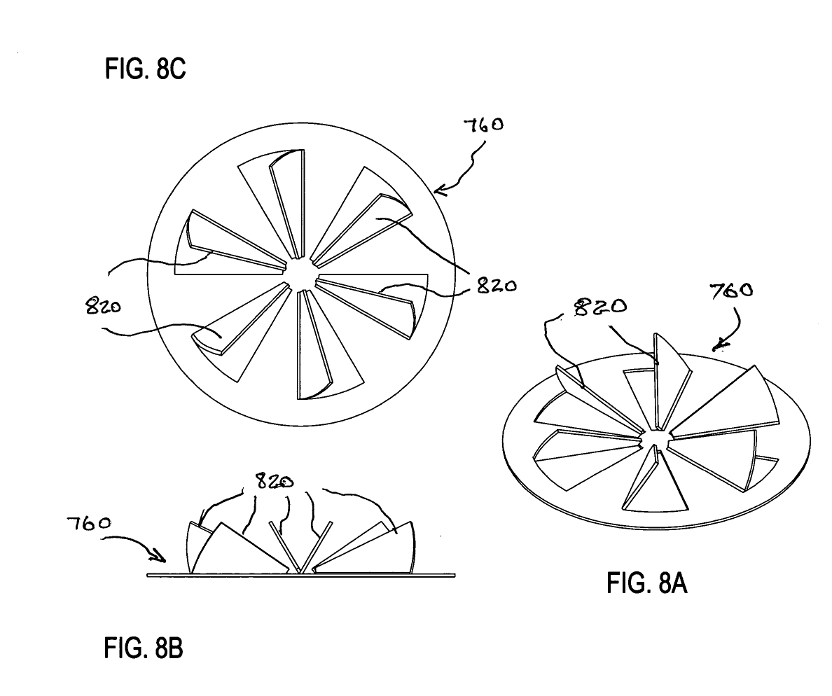

FIG. 7 depicts a second embodiment of the barbeque grill assembly which is shown with a simple cylindrical stack 16 and in which the central portion of the cover disposed atop the outlet of the stack is formed with a second type of air dispersing element 760, shown in greater detail in FIGS. 8a-8c. The air dispersing element 760 shown in FIGS. 8a-8c is seen to be comprised of a plate element having a plurality of triangularly shaped fins 820 punched upwardly from the plane of the plate element and arranged in a circular array. While shown as triangular shaped fins, it is to be understood that the fins could be formed in other shapes, such as rectangular or curvilinear, and further the fins could be formed by any other method, as for example stamping, folding, etc. That the fins are formed at an acute angle to the plane of the plate element is more important than the shape in which the fins are formed. The side of the plate element opposite the side from which the fins protrude is secured to the underside of the grill cover.

An air gap exists between the outer perimeter of the annular element 12 and the lower outer edge of the cover 22 due to the fact that the cover is disposed on the grill element 20, which in turn rests at a level atop and vertically spaced from the element 12 on the flange 18 of the stack 16. This air gap, resulting from the positioning of the cover relative to the annular element 12, allows heated air flowing within the cooking chamber to escape, and therefore induce further movement of heated air within the cooking chamber from the central portion of the cover above the stack through the cooking chamber and out through the air gap.

It is further to be understood that the flow of air through the cooking chamber could be controlled by placing a pair of annular straps (not shown) about the gap and adjusting the two straps relative to one another to alter the flow paths through the gap. One structural example to accomplish this would entail a providing the grilling assembly with first and second radially spaced, annular straps, each having spaced openings about its annular extent. The second strap would be mounted for annular movement relative to the first strap. When the user desired to change the amount or velocity of air flowing through the gap, he/she would slide the second strap annularly about the first strap so that the solid portions of the second strap could be moved to block some or all of the openings in the first strap.

When using the grill assembly 10 of the present invention in combination with a canister of propane or other fuel, the user first erects the legs 33 of the stand 40 by pivoting them outwardly relative to the grill assembly form a table structure. Next, the gas burner 34 is attached to the under side of the first annular element 12, and the latter is then placed horizontally on the stand with the burner suspended from and disposed below the first annular element. Next, the stack 16 is disposed atop the central opening in the element 12, the wire grill work element 20 is disposed atop the annular element 12 with the central opening in the element 20 being placed concentrically about the diameter of the stack 16, and a small amount of water is placed in the annular groove 32 of element 12. Next, the cover 22 is arranged in the position shown in FIGS. 1 and 2 and the parallel arms of the handle 26 are squeezed together to allow the two handle projections to be inserted together into the handle latching element 29. When the two handle projections 28, 28 have passed through the latching element 29, they are released whereupon they spread apart and secure the handle to the cover 22. The cover with secured handle is then disposed atop the elements 12 and 20, and the fuel canister 36 is attached to the conduit of the gas burner assembly 34. As shown in FIG. 2, the bottom of the cover is provided with an area 24 that has been marked with the warning “HOT SURFACE! DO NOT TOUCH!”.

Those skilled in the art will appreciate that various adoptions and modifications of the invention as described above can be configured without departing from the scope and spirit of the invention. Therefore, it is to be understood that, within the scope of the appended claims, the invention may be practiced other than as specifically described herein.

What I claim is:

1. A barbeque grill assembly, comprising:
a cooking chamber including
a liquid reservoir,
a first grilling member supported above said reservoir, said first grilling member including a foraminous planar element on which food to be grilled is arranged,
a cylindrical stack arranged centrally of said reservoir for channeling air heated below said first grilling member with said cooking chamber, and
a cover disposed over said reservoir, said first grilling member and said stack,
at least one of said cover and said stack including air flow impacting means for dispersing heated air throughout said cooking chamber.

2. The barbeque grill assembly of claim 1, wherein said planar element comprises concentric wire rings and radial wire elements.

3. The barbeque grill assembly of claim 1, wherein said planar element is supported above said grilling member by said stack.

4. The barbeque grill assembly of claim 1, and further including a heat source disposed beneath said liquid reservoir for heating ambient air.

5. The barbeque grill assembly of claim 4, wherein said stack comprises a tube having a diameter and an elongated longitudinal axis extending from a region adjacent the heat source to a region adjacent the central portion of said cover.

6. The barbeque grill assembly of claim 5, wherein said stack has a base with a diameter greater than the diameter of said tube.

7. The barbeque grill assembly of claim 5, wherein said planar element is supported on the base of said stack.

8. The barbeque grill assembly of claim 5, wherein the end of said stack adjacent said cover has a diameter smaller than the diameter of said tube.

9. The barbeque grill assembly of claim 8, wherein the end of said tube comprises radially inwardly directed flutes for increasing the speed of flow of heated air emanating from the upper portion of said stack.

10. The barbeque grill assembly of claim 5, wherein said stack includes air swirling means projecting into the conduit formed by said stack.

11. The barbeque grill assembly of claim 10, wherein said air swirling means comprises an array of deformed areas on the inner surface of said stack.

12. The barbeque grill assembly of claim 11, wherein said array of deformed areas on said stack surface comprises helically arranged inner wall protuberances projecting into the interior of said stack.

13. The barbeque grill assembly of claim 1, wherein said cover includes a conical formation at said central region thereof, said conical formation projecting toward said stack to impact heated air channeled through said stack.

14. The barbeque grill assembly of claim 1, wherein said cover includes air swirling means projecting toward the conduit formed by said stack.

15. The barbeque grill assembly of claim 14, wherein said air swirling means comprises an array of vanes disposed at an acute angle to the flow of heated air along the longitudinal axis of said stack.

16. The barbeque grill assembly of claim 4, wherein said cover is spaced vertically from said first grilling member so as to form an air gap therebetween, said air gap allowing heated air flowing within the cooking chamber to escape to the ambient, and thereby induce further introduction of heated air from within the stack into the cooking chamber after impinging on said air swirling means carried by one of said stack or said cover.
